(19) United States
(12) Patent Application Publication
(10) Pub. No.: US 2012/0055581 A1
(43) Pub. Date: Mar. 8, 2012

(54) LIQUID DELIVERY DEVIDE AND LIQUID CHROMATOGRAPHY DEVICE

(75) Inventors: Daisuke Akieda, Hitachinaka (JP); Kisaburo Deguchi, Hitachinaka (JP); Hironori Kaji, Hitachinaka (JP)

(73) Assignee: HITACHI HIGH-TECHNOLOGIES CORPORATION, Tokyo (JP)

(21) Appl. No.: 13/319,111

(22) PCT Filed: May 24, 2010
(86) PCT No.: PCT/JP2010/058735

§ 371 Date: Nov. 7, 2011

(30) Foreign Application Priority Data
May 26, 2009 (JP) 2009-126145

(51) Int. Cl. B65B 1/04; B01D 15/08

(52) U.S. Cl. 141/36; 210/198.2

(57) ABSTRACT

In a liquid delivery device, when an inlet-side check valve and an outlet-side check valve of a first cylinder are both closed, and compression of an eluent inside the first cylinder is started by means of a first plunger inside the first cylinder, a control unit doubles the rotational speed of a step motor, and measures the amount of change in the pressure inside the first cylinder which changes for a prescribed time by means of a first cylinder internal pressure detector. The time elapsed until the pressure inside the first cylinder is the same as the pressure inside a discharge-side flow passage is predicted using the rate of change over time of the pressure of the eluent. When the predicted elapsed time has elapsed, the rotational speed of the step motor is returned to the original speed, and the compression of the eluent inside the first cylinder is completed.

### TECHNICAL FIELD

The present invention relates to a liquid delivery device which is preferable for a liquid chromatography device, and a liquid chromatography device using the liquid delivery device.

### BACKGROUND ART

In a liquid delivery device used in a liquid chromatography device, a liquid delivery is carried out normally by two cylinders, and plungers which are provided in the cylinders and carry out approximately reverse phased reciprocating motions to each other. In the liquid delivery device mentioned above, even while one cylinder sucks a liquid to be delivered (hereinafter, refer to as an eluent), it is possible to discharge the eluent from another cylinder. Accordingly, a continuous liquid delivery can be stably achieved.

In the liquid delivery device mentioned above, first of all, an inlet-side check valve is released and an outlet-side check valve is closed, whereby the eluent is sucked into an inlet side cylinder. Next, the inlet-side check valve and the outlet-side check valve are both closed, and the eluent within the cylinder is compressed to a discharge side flow passage pressure from an atmospheric pressure. Further, when the pressure within the cylinder becomes the same as a discharge side flow passage internal pressure, the outlet-side check valve is released while keeping the inlet-side check valve being closed, and the eluent within the cylinder is discharged to a discharge side flow passage.

In the liquid delivery motion mentioned above, in order to obtain a stable discharge side flow passage pressure, a motor control driving the plunger at a high precision is necessary, and it is necessary to make the outlet-side check valve be released at a timing when the compression pressure within the inlet side cylinder coincides with the pressure of the discharge side flow passage so as to make the compression be stopped.

For example, in patent document 1 (JP-B2-3491948 (U.S. Pat. No. 5,637,208)) and patent document 2 (JP-B2-3709409 (U.S. Pat. No. 7,163,379)), there is disclosed an example of a liquid delivery device which is structured such that a pressure sensor detecting a pressure of an eluent is provided in each of an inlet side cylinder and a discharge side flow passage, and an outlet-side check valve is released and a compression is stopped at a time when both the pressure sensors become the same. In these examples, it is possible to accurately detect a timing when the compression pressure within the cylinder coincides with the discharge side flow passage internal pressure.

### SUMMARY OF THE INVENTION

### Problem to be Solved by the Invention

However, even in the liquid delivery device as mentioned above, there has been known that the discharge side flow passage internal pressure fluctuates in synchronous with a motion cycle of the plunger. This is caused by a generation of a time delay until the check valve is released after the coincidence of the pressure is detected, even if the timing at which the compression pressure within the cylinder coincides with the discharge side flow passage internal pressure can be accurately detected. In other words, since the check valve is not released immediately even if the coincidence of the pressure is detected, the pressure tends to overshoot.

Accordingly, it is preferable to carry out such a control as a check valve release or the like in an early stage, while taking a time delay into consideration, however, since a compression rate is different in accordance with a kind and a temperature of the eluent, an amount of the time delay could not be defined to a fixed value.

An object of the present invention is to provide a liquid delivery device which can achieve a liquid delivery having a small pressure fluctuation regardless of a kind and a temperature of a liquid to be delivered, while taking the problem in the prior art mentioned above into consideration, and a chromatography device using the liquid delivery device.

### Means for Solving the Problem

In accordance with a first aspect of the present invention, there is provided a liquid delivery device comprising:

a first cylinder and a second cylinder which are connected in series and are provided in this order from an upstream side; and

an eluent being delivered on the basis of a reciprocating motion of a plunger which is provided in each of the cylinders,

wherein if an inlet side flow passage and an outlet side flow passage of the first cylinder are both closed, and a compression of the eluent within the first cylinder is started by the plunger within the first cylinder, it measures a pressure within the first cylinder changing for a predetermined time, calculates a time change rate of the pressure of the eluent on the basis of an amount of change of the pressure, estimates an elapsed time until the pressure within the first cylinder comes to the same as the pressure in the discharge side flow passage on the basis of the measured time change rate of the pressure, and finishes the compression of the eluent within the first cylinder at a time when the estimated elapsed time has passed.

In accordance with the liquid delivery device described in the first aspect, after the compression of the eluent within the first cylinder is started, the time change rate of the pressure of the eluent is calculated on the basis of the change amount of the measured pressure within the first cylinder, and the elapsed time until the pressure within the first cylinder comes to the same as the pressure within the discharge side flow passage is estimated on the basis of the time change rate of the pressure. Accordingly, even in the case that the compression rate is different in accordance with the kind or the temperature of the eluent, the elapsed time is estimated at a high precision in correspondence to the kind or the temperature of the eluent.

Further, in order to detect the timing at which the pressure within the first cylinder comes to the same as the pressure within the discharge side flow passage, it is not necessary to monitor whether or not the pressures of the both become the same while measuring the pressure within the first cylinder and the pressure within the discharge side flow passage as is different from the conventional one, but it is only necessary to wait an elapse of the estimated elapsed time. Therefore, since the time delay demanded for detecting and comparing the pressures is not generated, it is possible to finish the compression of the eluent within the first cylinder immediately by determining that the pressure within the first cylinder comes to the same as the pressure within the discharge side flow passage, if the estimated elapsed time has passed. Accordingly, it is possible to prevent the pressure within the first cylinder from overshooting.

Therefore, in accordance with the liquid delivery device described in the first aspect, it is possible to obtain the stable pressure within the discharge side flow passage regardless of the kind, the temperature or the like of the eluent.

In accordance with a second aspect of the present invention, there is provided a liquid delivery device comprising:

a first cylinder and a second cylinder which are connected to each other via a flow passage conduit pipe;

a first plunger and a second plunger which are provided in inner portions of the first cylinder and the second cylinder, and reciprocate within the respective cylinders;

an inlet-side check valve which is provided in an inlet side flow passage of the first cylinder;

an outlet-side check valve which is provided in the flow passage conduit pipe of the outlet side flow passage from the first cylinder;

a cylinder internal pressure detector which measures a pressure within the first cylinder;

a discharge side flow passage internal pressure detector which measures a pressure within the discharge side flow passage from the second cylinder;

a motor which drives the first plunger and the second plunger in such a manner as to carry out reciprocating motions having approximately reverse phases;

a control unit which controls a rotation of the motor; and

an eluent being sucked into the first cylinder from the inlet side flow passage, and

the eluent within the second cylinder is discharged from the discharge side flow passage, if a moving direction of the first plunger is turned to a direction of enlarging a volumetric capacity within the first cylinder from a direction of reducing it, the outlet-side check valve is closed, and the inlet-side check valve is released,

wherein the following features are provided.

(1) the control unit is structured such that when the moving direction of the first plunger is turned to the direction of reducing the volumetric capacity within the first cylinder from the direction of enlarging it, the inlet-side check valve is closed, and the compression of the eluent within the first cylinder is started, (1-1) it increases a rotational speed of the motor, (1-2) measures a change amount of the pressure within the first cylinder until a predetermined first elapsed time has passed before the pressure within the first cylinder reaches the pressure within the discharge side flow passage, from the compression starting time of the eluent within the first cylinder, by means of the cylinder internal pressure detector, (1-3) calculates a time change rate of the pressure within the first cylinder on the basis of the first elapsed time and the measured change amount of the pressure within the first cylinder, (1-4) estimates a second elapsed time until the pressure within the first cylinder comes to the same pressure as that within the discharge side flow passage after starting the compression of the eluent within the first cylinder, on the basis of the time change rate of the pressure, and (1-5) determines that the pressure within the first cylinder comes to the same pressure as that within the discharge side flow passage in the case that the elapsed time after starting the compression of the eluent within the first cylinder reaches the estimated second elapsed time, thereby executing such a process as to reduce the rotational speed of the motor to a speed before being increased.

(2) Further, when the rotational speed of the motor is reduced on the basis of the process, the outlet-side check valve is opened, the compression of the eluent within the first cylinder is finished, the eluent within the first cylinder is delivered to the second cylinder, and the eluent overflowing from the second cylinder is discharged out of the discharge side flow passage.

In accordance with the liquid delivery device described in the second aspect, the control device increases the rotational speed of the motor and compresses the eluent at a high speed if the compression of the eluent within the first cylinder is started. Further, before the pressure within the first cylinder reaches the pressure within the discharge side flow passage, it determines the time change rate of the pressure within the first cylinder, estimates the elapsed time (the second elapsed time) until the pressure within the first cylinder comes to the same pressure as that within the discharge side flow passage on the basis of the time change rate, reduces the rotational speed of the motor to the original speed at a time when the estimated elapsed time has passed, and stops the compression of the eluent.

In other words, since the time change rate of the pressure of the eluent within the first cylinder is actually measured, the elapsed time (the second elapsed time) until the pressure within the first cylinder comes to the same pressure as that within the discharge side flow passage can be estimated at a high precision in correspondence to the kind and the temperature of the eluent, even in the case that the compression rate is different in accordance with the kind and the temperature of the eluent.

Further, it is not necessary to monitor whether or not both the pressures come to the same, while measuring the pressure within the first cylinder and the pressure within the discharge side flow passage as is different from the conventional one, for detecting the timing at which the pressure within the first cylinder comes to the same pressure as that within the discharge side flow passage, but it is only necessary to wait for the passage of the estimated elapsed time, a time delay which is necessary for detecting and comparing the pressures is not generated. Accordingly, since it is possible to finish the compression of the eluent within the first cylinder immediately after the pressure within the first cylinder comes to the same pressure as that within the discharge side flow passage, it is possible to prevent the pressure within the first cylinder from overshooting.

Therefore, in accordance with the liquid delivery device described in the second aspect, it is possible to obtain the stable pressure within the discharge side flow passage regardless of the kind, the temperature or the like of the eluent.

A liquid delivery device described in a third aspect is the liquid delivery device as described in the second aspect, wherein the control device further (3) measures a difference between the pressure obtained from the cylinder internal pressure detector and the pressure obtained from the pressure detector within the discharge side flow passage, at a time when the inlet-side check valve is closed and the outlet-side check valve is opened, (4) determines the time change rate of the pressure within the discharge side flow passage, on the basis of a pressure change amount of the pressures which are obtained from the pressure detector within the discharge side flow passage respectively at a time of starting the suction of the eluent into the first cylinder and a time of starting the compression of the eluent into the first cylinder, and a third elapsed time from the suction starting time to the compression starting time, and (5) employs a pressure which is estimated by taking into consideration the time change rate of the pressure within the discharge side flow passage and the difference, as the pressure within the discharge side flow passage, at a time of estimating the second elapsed time.

In accordance with the liquid delivery device described in the third aspect, the difference between the pressure detected by the cylinder internal pressure detector and the pressure detected by the pressure detector within the discharge side flow passage, and the time change rate of the pressure within the discharge side flow passage are actually measured, and the actually measured values are used for estimating the elapsed time (the second elapsed time) until the pressure within the first cylinder comes to the same pressure as that within the discharge side flow passage. Therefore, it is possible to estimate the second elapsed time at a higher precision. As a result, it is possible to obtain a more stable pressure within the discharge side flow passage.

A liquid delivery device described in a fourth aspect is the liquid delivery device as described in the second aspect, wherein in the case of taking into consideration a time change rate Kₒᵤₜ of the pressure within the discharge side flow passage and the difference Pₛ, the second elapsed time x is calculated by the following expression.

$$x = \frac{{K}_{out} \cdot {S}_{s} + {P}_{0} - {P}_{1}}{{K}_{in} - {K}_{out}} \qquad [ Numerical expression 1 ]$$

In which P₀ is a pressure within the first cylinder which is obtained from the cylinder internal pressure detector at the suction starting time, P₁ is a pressure within the first cylinder which is obtained from the cylinder internal pressure detector at the compression starting time, P₂ is a pressure within the discharge side flow passage which is obtained from the pressure within the discharge side flow at the compression starting time, Kᵢₙ is a time change rate of the calculated pressure within the first cylinder, and Sₛ is the third elapsed time.

In accordance with the liquid delivery device described in the fourth aspect, the elapsed time until the pressure within the first cylinder comes to the same pressure as that within the discharge side flow passage, that is, the second elapsed time x can be calculated, on the basis of the expression which includes the difference Pₛ between the pressure detected by the cylinder internal pressure detector and the pressure detected by the pressure detector within the discharge side flow passage, the time change rate Kₒᵤₜ of the pressure within the discharge side flow passage, and the time change rate of Kᵢₙ the pressure within the first cylinder. Accordingly, it is possible to estimate the second elapsed time at a higher precision. As a result, it is possible to obtain a more stable pressure within the discharge side flow passage.

A liquid delivery device described in a fifth aspect is the liquid delivery device as described in the third aspect, wherein the control device measures the first elapsed time and the second elapsed time by counting pulses which are output in correspondence to an amount of rotation of the motor.

In accordance with the liquid delivery device described in the fifth aspect, it is only necessary for the control device to count the estimated pulse number for detecting the timing at which the pressure within the first cylinder comes to the same pressure as that within the discharge side flow passage. Therefore, it is not necessary to monitor whether or not both the pressure come to the same while measuring the pressure within the first cylinder and the pressure within the discharge side flow passage, as is different form the conventional one, but a processing load of the control device can be reduced.

A liquid delivery device described in a sixth aspect is a liquid delivery device constructed by using two liquid delivery devices as described in any one of the first to fifth aspects, wherein the discharge side flow passages of these two liquid delivery devices are structured such as to be combined with one flow passage.

The liquid delivery device described in the sixth aspect is generally a liquid delivery device which is called as a gradient type liquid delivery device, and has the same operations and effects as those of the liquid delivery device described in the first to fifth aspects.

A liquid chromatography device described in a seventh aspect is constructed by including the liquid delivery device as described in any one of the first to sixth aspects.

Accordingly, the liquid chromatography device described in the seventh aspect has the same operations and effects as those of the liquid delivery device as described in any one of the first to sixth aspects.

### Effect of the Invention

In accordance with the present invention, there can be provided the liquid delivery device which can delivery the liquid while having a small pressure fluctuation regardless of the kind or the temperature of the liquid to be delivered, and the chromatograph device which uses the liquid delivery device.

Other objects, features and advantages of the invention will become apparent from the following description of the embodiments of the invention taken in conjunction with the accompanying drawings.

### BRIEF DESCRIPTION OF THE DRAWINGS

FIG. 1 is a view showing an example of an outline structure of a liquid chromatography device in accordance with a first embodiment of the present invention;

FIG. 2 is a view showing an example of a structure of a liquid delivery device in accordance with the first embodiment of the present invention;

FIG. 3 is a view showing an example of a time transition of a pressure within a first cylinder and a pressure within a discharge side flow passage, in the liquid delivery device in accordance with the first embodiment of the present invention; and

FIG. 4 is a view showing an example of a structure of a gradient type liquid delivery device in accordance with a second embodiment of the present invention.

### MODE FOR CARRYING OUT THE INVENTION

A description will be in detail given below of embodiments in accordance with the present invention appropriately with reference to the accompanying drawings.

### First Embodiment

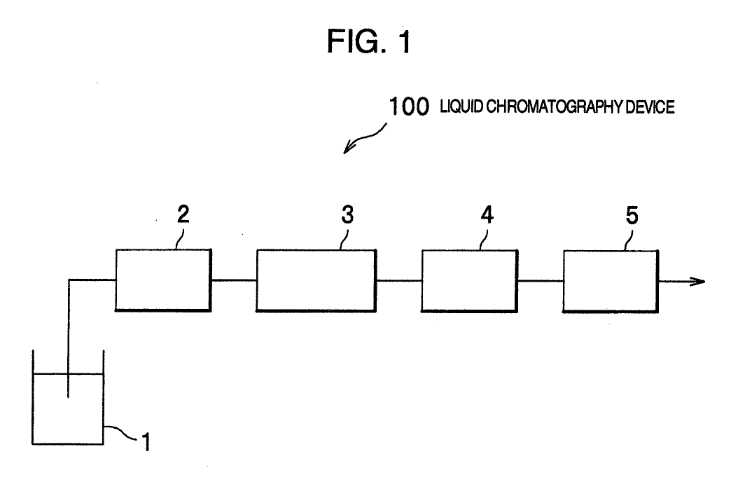

FIG. 1 is a view showing an example of an outline structure of a liquid chromatography device. As shown in FIG. 1, a liquid chromatography device 100 is structured such as to be provided with an eluent 1 which corresponds to a liquid to be analyzed, a liquid delivery device 2 which delivers the eluent 1, a sample injection portion 3 which injects a sample to be analyzed, a column 4 which separates a material included in the sample, and a detector 5 which detects the separated material.

In FIG. 1, the eluent 1 is sucked by the liquid delivery device 2, and is delivered to the column 4 via the sample injection portion 3 at a fixed pressure by the liquid delivery device 2. In this case, in the sample injection portion 3, a sample to be analyzed, an auxiliary solvent and the like are injected to the eluent. Further, a filler such as a silica gel or the like is squeezed into the column 4, and a component material included in the eluent is separated in accordance with an adsorption, a filtration or the like. Further, the detector 5 generally employs an absorbance detector which analyzes a wavelength of an absorbed light, a fluorescence detector which detects a fluorescence which the separated material radiates, and the like, however, an electric conductivity meter and a mass spectrograph may be employed.

### First Embodiment

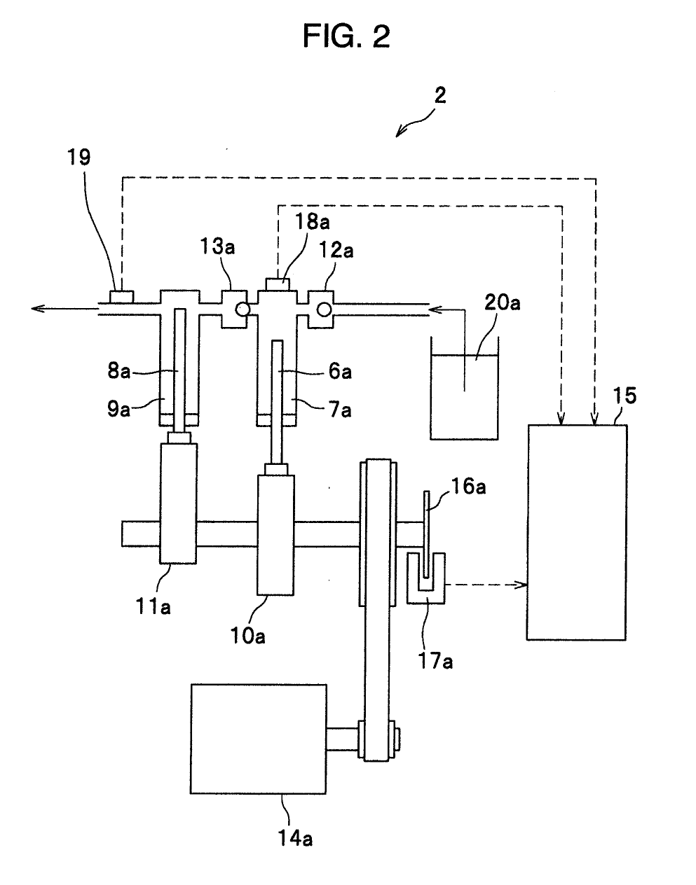

FIG. 2 is a view showing an example of a structure of the liquid delivery device 2 in accordance with the first embodiment of the present invention. As shown in FIG. 2, the liquid delivery device 2 is structured such that a first cylinder 7a and a second cylinder 9a are connected in series alphabetically from an upstream side from which the eluent 1 is delivered, and an inner portion of the first cylinder 7a and an inner portion of the second cylinder 9a are communicated by a flow passage conduit pipe. Further, a first plunger 6a and a second plunger 8a are provided respectively in inner portions of the first cylinder 7a and the second cylinder 9a.

The first plunger 6a is driven on the basis of a rotation of a first cam 10a, and reciprocates in the inner portion of the first cylinder 7a. Further, the second plunger 8a is driven on the basis of a rotation of the second cam 11a, and reciprocates in the inner portion of the second cylinder 9a. At this time, the rotation of the first cam 10a and the second cam 11a is driven on the basis of a rotation of a step motor 14a via a belt or the like.

Further, to rotating shafts of the first cam 10a and the second cam 11a, there is attached a discoid slit member 16a rotating together with the rotating shafts. A slit is provided at a predetermined position of an outer peripheral portion of the slit member 16a, and a cam position detecting sensor 17a detecting the slit and detecting a cam position is further provided.

Further, as shown in FIG. 2, an inlet-side check valve 12a is provided in a flow passage in an inlet side of the first cylinder 7a which sucks an eluent 20a, and an outlet-side check valve 13a is provided in a flow passage conduit pipe of a communication portion with the second cylinder 9a in an outlet side flow passage of the first cylinder 7a. Further, the first cylinder 7a is provided with a first cylinder internal pressure detector 18a which detects a pressure in the inner portion of the first cylinder 7a, and a discharge side flow passage inside pressure detector 19 is provided in an outlet side flow passage portion of the second cylinder 9a.

The pressure in the first cylinder which is detected by the first cylinder internal pressure detector 18a and the discharge side flow passage inside pressure in the outlet side from the second cylinder which is detected by the discharge side flow passage inside pressure detector 19 are input to a control unit 15. The control unit 15 controls a rotational speed of the step motor 14a, and executes a process of calculating a time change rate of a compression pressure or the like at a time when the eluent within the first cylinder is compressed, as mentioned below.

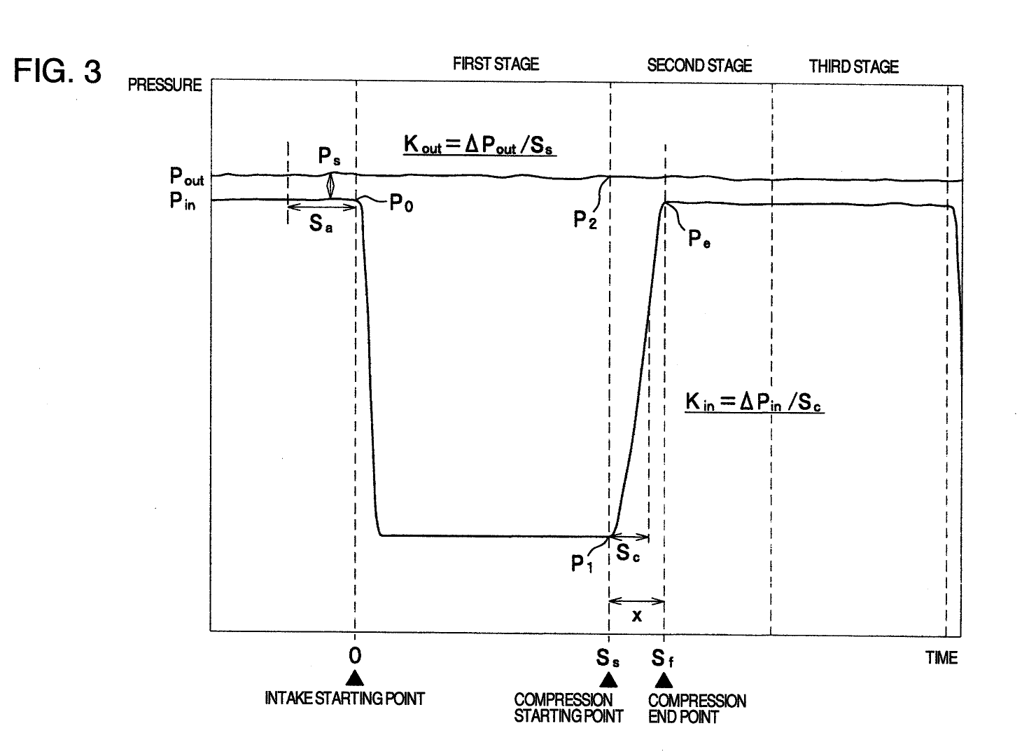

Subsequently, a description will be given of a liquid delivering motion in the liquid delivery device 2 with reference to FIG. 2 and FIG. 3. In this case, FIG. 3 is a view showing an example of a time change of the pressure within the first cylinder 7a and the discharge side flow passage inside pressure.

The liquid delivery in the liquid delivery device 2 is carried out on the basis of a reciprocating motion of the first plunger 6a and the second plunger 8a respectively within the first cylinder 7a and within the second cylinder 9a. At this time, the first plunger 6a and the second plunger 8a carry out reverse phase reciprocating motions to each other except a partial section (a section of a second stage mentioned later). In other words, when the first plunger 6a (the second plunger 8a) moves in a direction of increasing a volumetric capacity within the first cylinder 7a (the second cylinder 9a), another second plunger 8a (first plunger 6a) moves in a direction of reducing a volumetric capacity within the second cylinder 9a (the first cylinder 7a).

The liquid delivering motion of the liquid delivery device 2 is divided into the following three stages, in correspondence to the motion conditions of the first plunger 6a and the second plunger 8a.

The moving direction of the first plunger 6a is turned to the direction of increasing the volumetric capacity within the first cylinder 7a from the direction of reducing it, on the basis of a function of the first cam 10a, whereby the first stage is started. Further, at this time, the moving direction of the second plunger 8a is simultaneously turned to the direction of reducing the volumetric capacity within the second cylinder 9a from the direction of increasing it, the inlet-side check valve 12a is further opened, and the outlet-side check valve 13a is closed.

In other words, in the first stage, the first plunger 6a moves in the direction of increasing the volumetric capacity within the first cylinder 7a in a state in which the inlet-side check valve 12a is opened, and the outlet-side check valve 13a is closed. Accordingly, the eluent 20a is sucked into the first cylinder 7a. In the present embodiment, this suction starting point is set to a starting point of the first stage (refer to FIG. 3).

Further, at this time, since the second plunger 8a moves in the direction of reducing the volumetric capacity within the second cylinder 9a in a state in which the outlet-side check valve 13a is closed, the eluent reserved within the second cylinder 9a is discharged from the second cylinder 9a. Accordingly, in the first stage, the liquid delivery of the eluent is carried out by the second plunger 8a.

Subsequently, if the moving direction of the first plunger 6a is turned to the direction of reducing the volumetric capacity within the first cylinder 7a from the direction of increasing it, the inlet-side check valve 12a is closed, and gives way to a second stage.

Coming to the second stage, the control unit 15 sets the rotational speed of the step motor 14a to double speed, however, since both the inlet-side check valve 12a and the outlet-side check valve 13a are in the closed state at this time, the volumetric capacity within the first cylinder 7a is rapidly reduced, and the eluent within the first cylinder 7a is accordingly compressed rapidly. In the present embodiment, this compression starting point is set to a starting point of the second stage (refer to FIG. 3).

At this time, since the second plunger 8a still moves in the direction of reducing the volumetric capacity within the second cylinder 9a, the eluent is discharged from the second cylinder 9a. Accordingly, the liquid delivery of the eluent is carried out by the second plunger 8a in the second stage.

Further, in this second stage, the control unit 15 measures a compression pressure P₁ within the first cylinder 7a and a discharge side flow passage inside pressure P₂ at the compression starting point by the first cylinder internal pressure detector 18a and the discharge side flow passage inside pressure detector 19. Further, when a predetermined time (a time corresponding to Sc in FIG. 3) which is previously defined before a compression pressure Pᵢₙ within the first cylinder 7a reaches a discharge side flow passage inside pressure Pout has passed from the compression starting point, a compression pressure Pₘ within the first cylinder 7a is measured.

The control unit 15 calculates a time change rate of the pressure of the eluent within the first cylinder 7a on the basis of a change amount (Pₘ−P₁) of the compression pressure within the first cylinder 7a, and estimates an elapsed time until the compression pressure Pᵢₙ within the first cylinder 7a becomes the same pressure as the discharge side flow passage inside pressure Pout on the basis of a time change rate of the pressure. Further, when the elapsed time has passed, it determines that the compression pressure Pᵢₙ within the first cylinder 7a becomes the same as the discharge side flow passage inside pressure Pout, and brings back the rotational speed of the step motor 14a to the original speed from the double speed.

The outlet-side check valve 13a is opened on the basis of the change of the pressure at a time when the rotational speed of the step motor 14a is brought back to the original speed from the double speed, and the compression of the eluent within the first cylinder 7a is finished (refer to FIG. 3: compression end point).

If the outlet-side check valve 13a is opened, the liquid delivery of the eluent is carried out by both the first plunger 6a and the second plunger 8a. In other words, at this time, the first plunger 6a and the second plunger 8a respectively move in the direction of reducing the volumetric capacities of the first cylinder 7a and the second cylinder 9a.

Subsequently, if the second plunger 8a turns the moving direction thereof from the direction of reducing the volumetric capacity within the second cylinder 9a to the direction of increasing it, the stage gives way to a third stage.

In this third stage, the inlet-side check valve 12a is closed, and the outlet-side check valve 13a is in the opened state. At this time, since the first plunger 6a moves in the direction of reducing the volumetric capacity within the first cylinder 7a, the liquid delivery of the eluent is carried out by the first plunger 6a. Further, the second plunger 8a moves in the direction of increasing the volumetric capacity within the second cylinder 9a, the suction of the eluent is carried out with respect to the second cylinder 9a.

Next, the first plunger 6a turns its moving direction from the direction of reducing the volumetric capacity within the first cylinder 7a to the direction of increasing it, the second plunger 8a turns its moving direction from the direction of increasing the volumetric capacity within the second cylinder 9a to the direction of reducing it at the same time, the inlet-side check valve 12a is further opened, the outlet-side check valve 13a is closed, and the stage gives way to the first stage.

In the present embodiment, if the control unit 15 gives way to the second stage, it determines a pressure change rate Kᵢₙ within the first cylinder 7a on the basis of the compression pressure Pᵢₙ within the first cylinder 7a obtained from the first cylinder internal pressure detector 18a. Further, it estimates an elapsed time until the compression pressure Pᵢₙ within the first cylinder 7a coincides with the discharge side flow passage inside pressure Pout from the second cylinder 9a by using the pressure change rate Kᵢₙ. A description will be further in detail given below of a calculating method of the elapsed time with reference to FIG. 3.

In FIG. 3, a horizontal axis of a graph indicates a time, a vertical axis thereof indicates a pressure, Pᵢₙ indicates a time transition of the compression pressure within the first cylinder 7a, and Pout indicates a time transition of the discharge side flow passage inside pressure from the second cylinder 9a. In this case, the time is structured such as to be measured, for example, by counting a pulse (for example, a pulse which is output per one rotation) which is output in correspondence to an amount of rotation from the step motor 14a.

In an example in FIG. 3, if the counting of the pulse is started on the basis of the starting point of the first state, that is, the suction starting point, and the pulse number obtained at the starting point of the second stage, that is, the compression starting point is set to Sₛ, a duration of the first stage is expressed by Sₛ·Δt in which Δt is a cycle of the pulse. Therefore, if Δt is assumed to be a unit time, the duration can be expressed by Sₛ.

First of all, in the third stage, a measuring instrument difference Pₛ is determined. For this purpose, the control unit 15 is in a state in which the inlet-side check valve 12a is closed and the outlet-side check valve 13a is opened. The counting of the pulse is started from a certain time point, and a pulse number Sₐ at the starting point of the first stage, that is, the suction starting point is obtained. Further, there is determined an average value Pₛ of differences between the compression pressure Pᵢₙ within the first cylinder 7a which is measured by the first cylinder internal pressure detector 18a, and the discharge side flow passage inside pressure Pout which is measured by the discharge side flow passage inside pressure detector 19, in this section. The value Pₛ determined as mentioned above corresponds to the measuring instrument difference between the pressure which is measured by the first cylinder internal pressure detector 18a, and the pressure which is measured by the discharge side flow passage inside pressure detector 19.

Next, the pulse number at the starting point of the first stage, that is, the suction starting point is set to 0, and the pressure within the first cylinder 7a which is measured by the first cylinder internal pressure detector 18a is set to P₀. Further, the pulse number at the starting point of the second stage, that is the compression starting point is set to Sₛ, the pressure within the first cylinder 7a which is measured by the first cylinder internal pressure detector 18a is set to P₁, and the discharge side flow passage inside pressure which is measured by the discharge side flow passage inside pressure detector 19 is set to P₂.

Next, if the stage enters into the second stage, the control unit 15 starts the counting of the pulse number newly from 0, and acquires the compression pressure Pₘ within the first cylinder 7a which is measured at that time, from the first cylinder internal pressure detector 18a at a certain time point (for example, a time point when the counting number of the pulse number comes to a predetermined pulse number Sc) before the compression pressure Pᵢₙ within the first cylinder 7a reaches the discharge side flow passage inside pressure P₂.

In accordance with this, the control unit 15 can calculate a time change rate Kᵢₙ of the pressure of the eluent within the first cylinder 7a until a time point when the pulse counting number comes to Sc from the compression starting point, in accordance with the following expression.

Kᵢₙ=ΔPᵢₙ/S_{c}, ΔPᵢₙ=Pₘ−P₁

If the pressure change rate Kᵢₙ calculated as mentioned above is used, it is possible to estimate a pulse number x at a time when the compression pressure Pᵢₙ within the first cylinder 7a reaches the discharge side flow passage inside pressure P₂. A description will be given below of a procedure of calculating the pulse number x, however, this case takes into consideration the previously calculated measuring instrument difference Pₛ and the pressure change rate Kₒᵤₜ of the discharge side flow passage inside pressure Pₒᵤₜ.

Accordingly, the control unit 5 calculates the pressure change rate Kₒᵤₜ of the discharge side flow passage inside pressure Pout in accordance with the following expression, on the basis of the duration Sₛ of the first stage, the measuring instrument difference Pₛ, the pressure P₀ within the first cylinder 7a at the suction starting point, and the pressure P₁ within the first cylinder 7a at the compression starting point.

Kₒᵤₜ=ΔPₒᵤₜ/Sₛ, ΔPₒᵤₜ=P₂−(P₀+Pₛ)

In this case, the compression pressure Pᵢₙ within the first cylinder 7a and the discharge side flow passage inside pressure Pout at a time point when the pulse number comes to x in the second stage are respectively expressed by the following expressions (1) and (2).

Pᵢₙ=Kᵢₙ·x+P₁ (1)

Pₒᵤₜ=Kₒᵤₜ·(Sₛ+x)+P₀+Pₛ (2)

At this time, taking into consideration the measuring instrument difference, since a relationship Pᵢₙ=Pₑ=Pₒᵤₜ−Pₛ is established at a time when the compression pressure Pᵢₙ within the first cylinder 7a comes to the same pressure Pₑ as the discharge side flow passage inside pressure Pout, the following expression (3) can be obtained on the basis of the expressions (1) and (2).

Kᵢₙ·x+P₁=Kₒᵤₜ·(Sₛ+x)+P₀ (3)

Further, the expression (4) can be obtained by solving the expression (3) for x.

$$\begin{matrix}[ Numerical Expression 2 ] & \\ x = \frac{{K}_{out} \cdot {S}_{s} + {P}_{0} - {P}_{1}}{{K}_{in} - {K}_{out}} & ( 4 )\end{matrix}$$

Accordingly, the control unit 15 can estimate the pulse number x expressing the elapsed time from the compression starting time point until the compression pressure Pᵢₙ within the first cylinder 7a comes to the same pressure as the discharge side flow passage inside pressure P₂. In other words, if the control unit 15 calculates the pulse number x in accordance with the expression (4) after calculating the pressure change rate Kᵢₙ within the first cylinder 7a, it can determine that the compression pressure Pᵢₙ comes to the same pressure as the discharge side flow passage inside pressure Pout by detecting that the pulse number which the counting is started after the compression starting point reaches x.

The control unit 15 brings back the rotational speed of the step motor 14a from the double speed to the original speed, at a time when it determines that the compression pressure Pᵢₙ comes to the same pressure as the discharge side flow passage inside pressure Pout. Further, the outlet-side check valve 13a is opened, and the compression of the eluent in the first cylinder 7a is finished.

As mentioned above, in the case of estimating the timing at which the compression pressure Pᵢₙ within the first cylinder 7a comes to the same pressure as the discharge side flow passage inside pressure Pout, and outputting a signal for opening the outlet-side check valve 13a at a time of the timing, the following effects can be obtained.

First of all, since the time change rate Kᵢₙ of the pressure of the eluent is calculated by measuring the pressure of the eluent during the compression of the eluent within the first cylinder 7a, and the elapsed time until the compression pressure Pᵢₙ within the first cylinder 7a comes to the same as the discharge side flow passage inside pressure Pout is measured on the basis of the time change rate Kᵢₙ of the pressure, it is possible to estimate an accurate elapsed time in correspondence to the compression rate of the eluent, even in the case that the compression rate of the eluent is different in correspondence to the kind or the temperature.

Further, the control unit 15 can detect the timing at which the compression pressure Pᵢₙ within the first cylinder 7a comes to the same pressure as the discharge side flow passage inside pressure Pout, only by waiting for the passage of the determined elapsed time (pulse number). In other words, since it is not necessary to monitor whether or not both the pressures become the same, while measuring the pressure Pᵢₙ within the first cylinder and the pressure Pout within the discharge side flow passage, as is different from the conventional one, the processing load of the control unit 15 can be widely reduced.

Further, since it is possible to detect the timing at which the pressure within the first cylinder becomes the same pressure as the pressure within the discharge side flow passage without measuring the pressure within the first cylinder and the pressure within the discharge side flow passage, a time delay for measuring the pressure generated at a time of detecting is not generated. Therefore, it is possible to prevent the pressure within the first cylinder from overshooting. As a result, it is possible to more stabilize the discharge side flow passage inside pressure Pout.

### Second Embodiment

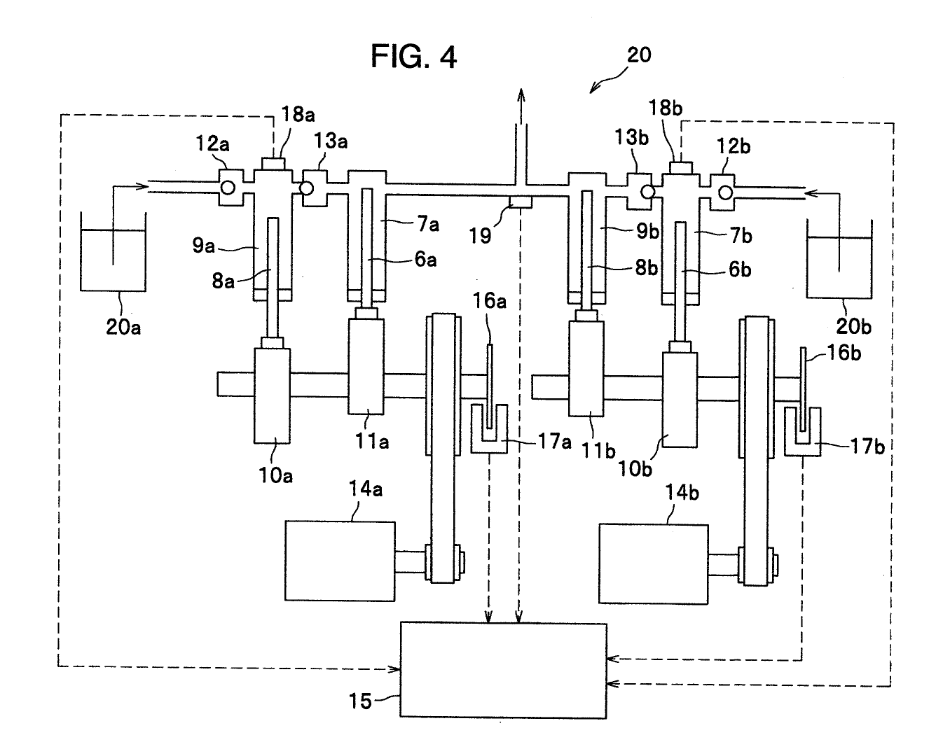

FIG. 4 is a view showing an example of a structure of a gradient type liquid delivery device 20 in accordance with a second embodiment of the present invention. The gradient type liquid delivery device 20 is constructed by connecting two liquid delivery devices 2 in accordance with the first embodiment in parallel. In the gradient type liquid delivery device 20, it is possible to deliver an eluent 20a and an eluent 20b in accordance with an optional mixing ratio.

In the gradient type liquid delivery device 20, the other constructing elements and their functions are the same as those of the liquid delivery device 20 in accordance with the first embodiment, except a matter that the discharge side flow passages of two liquid delivery devices 2 are connected so as to be combined into one, and a matter that the discharge side flow passage inside pressure detector 19 and the control unit 15 are used in common.

Accordingly, as shown in FIG. 4, in the gradient type liquid delivery device 20, first plungers 6a and 6b provided in first cylinders 7a and 7b are driven by first cams 10a and 10b so as to reciprocate. Further, second plungers 8a and 8b provided in second cylinders 9a and 9b are driven by second cams 11a and 11b so as to reciprocate. Further, the first cylinders 7a and 7b are provided with inlet side check vales 12a and 12b and outlet-side check valves 13a and 13b.

The cam (the first cams 10a and 12b and the second cams 11a and 11b) are rotationally driven by step motors 14a and 14b, and discoid slit members 16a and 16b provided with slits for determining a position of the cam are attached to rotating shafts of the cams. Further, the position of the cam is determined by detecting the slits of the slit members 16a and 16b by cam position detecting sensors 17a and 17b.

Further, in the second embodiment, as shown in FIG. 4, three pressure detectors are provided. First cylinder internal pressure detectors 18a and 18b are compensated by a discharge side flow passage inside pressure which a discharge side flow passage inside pressure detector 19 detects in a state in which the inlet-side check valves 12a and 12b are closed, and the outlet-side check valves 13a and 13b are opened.

Further, a method of stopping the compression within the first cylinders 7a and 7b at t time when the first plungers 6a and 6b compress the eluent within the first cylinders 7a and 7b and the pressure within the first cylinders 7a and 7b comes to the same pressure as the pressure detected by the discharge side flow passage inside pressure detector is the same as the method described in accordance with the first embodiment. Therefore, even in the gradient type liquid delivery device 20 in accordance with the second embodiment, it is possible to obtain the same effect as that of the liquid delivery device 2 in accordance with the first embodiment.

It should be further understood by those skilled in the art that although the foregoing description has been made on embodiments of the invention, the invention is not limited thereto and various changes and modifications may be made without departing from the spirit of the invention and the scope of the appended claims.

### DESCRIPTION OF REFERENCE NUMERALS

1, 20a, 20b eluent
2 liquid delivery device
3 sample injection portion
4 column
5 detector
6a, 6b first plunger
7a, 7b first cylinder
8a, 8b second plunger
9a, 9b second cylinder
10a, 10b first cam
11a, 11b second cam
12a, 12b inlet-side check valve
13a, 13b outlet-side check valve
14a, 14b step motor
15 control unit
16a, 16b slit member
17a, 17b cam position detecting sensor
18a, 18b first cylinder internal pressure detector
19 discharge side flow passage inside pressure detector
20 gradient type liquid delivery device
100 liquid chromatography device

1. A liquid delivery device comprising:
a first cylinder and a second cylinder which are connected in series and are provided in this order from an upstream side; and
an eluent being delivered on the basis of a reciprocating motion of a plunger which is provided in each of the cylinders,
wherein if an inlet side flow passage and an outlet side flow passage of said first cylinder are both closed, and a compression of the eluent within said first cylinder is started by the plunger within said first cylinder, it measures a pressure within said first cylinder changing for a predetermined time, calculates a time change rate of the pressure of the eluent on the basis of an amount of change of the pressure, estimates an elapsed time until the pressure within said first cylinder comes to the same as the pressure in the discharge side flow passage on the basis of said measured time change rate of the pressure, and finishes the compression of the eluent within said first cylinder at a time when said estimated elapsed time has passed.

2. A liquid delivery device comprising:
a first cylinder and a second cylinder which are connected to each other via a flow passage conduit pipe;
a first plunger and a second plunger which are provided in inner portions of said first cylinder and the second cylinder, and reciprocate within the respective cylinders;
an inlet-side check valve which is provided in an inlet side flow passage of said first cylinder;
an outlet-side check valve which is provided in said flow passage conduit pipe of the outlet side flow passage from said first cylinder;
a cylinder internal pressure detector which measures a pressure within said first cylinder;
a discharge side flow passage internal pressure detector which measures a pressure within the discharge side flow passage from said second cylinder;
a motor which drives said first plunger and the second plunger in such a manner as to carry out reciprocating motions having approximately reverse phases;
a control unit which controls a rotation of said motor; and
an eluent being sucked into said first cylinder from said inlet side flow passage, and the eluent within said second cylinder is discharged from the discharge side flow passage, if a moving direction of said first plunger is turned to a direction of enlarging a volumetric capacity within said first cylinder from a direction of reducing it, said outlet-side check valve is closed, and said inlet-side check valve is released,
wherein said control unit is structured such that when the moving direction of said first plunger is turned to the direction of reducing the volumetric capacity within said first cylinder from the direction of enlarging it, said inlet-side check valve is closed, and the compression of the eluent within said first cylinder is started,
said control unit increases a rotational speed of said motor,
said control unit measures a change amount of the pressure within said first cylinder until a predetermined first elapsed time has passed before the pressure within said first cylinder reaches the pressure within said discharge side flow passage, from the compression starting time of the eluent within said first cylinder, by means of said cylinder internal pressure detector,
said control unit calculates a time change rate of the pressure within said first cylinder on the basis of said first elapsed time and said measured change amount of the pressure within the first cylinder,
said control unit estimates a second elapsed time until the pressure within said first cylinder comes to the same pressure as that within said discharge side flow passage after starting the compression of the eluent within said first cylinder, on the basis of said time change rate of the pressure, and
said control unit determines that the pressure within said first cylinder comes to the same pressure as that within said discharge side flow passage in the case that the elapsed time after starting the compression of the eluent within said first cylinder reaches said estimated second elapsed time, thereby executing such a process as to reduce the rotational speed of said motor to a speed before being increased,
wherein when the rotational speed of said motor is reduced on the basis of the process, said outlet-side check valve is opened, the compression of the eluent within said first cylinder is finished, the eluent within said first cylinder is delivered to said second cylinder, and the eluent overflowing from said second cylinder is discharged out of said discharge side flow passage.

3. A liquid delivery device as claimed in claim 2, wherein said control device further measures a difference between the pressure obtained from said cylinder internal pressure detector and the pressure obtained from said pressure detector within the discharge side flow passage, at a time when said inlet-side check valve is closed and said outlet-side check valve is opened,
said control device determines the time change rate of the pressure within said discharge side flow passage, on the basis of a pressure change amount of the pressures which are obtained from said pressure detector within the discharge side flow passage respectively at a time of starting the suction of the eluent into said first cylinder and a time of starting the compression of the eluent into said first cylinder, and a third elapsed time from said suction starting time to said compression starting time, and
said control device employs a pressure which is estimated by taking into consideration the time change rate of the pressure within said discharge side flow passage and said difference, as the pressure within said discharge side flow passage, at a time of estimating said second elapsed time.

4. A liquid delivery device as claimed in claim 3, wherein in the case of taking into consideration a time change rate Kₒᵤₜ of the pressure within said discharge side flow passage and said difference Pₛ, said second elapsed time x is calculated by the following expression.
$$x = \frac{{K}_{out} \cdot {S}_{s} + {P}_{0} - {P}_{1}}{{K}_{in} - {K}_{out}} \qquad [ Numerical Expression 1 ]$$
in which P₀ is a pressure within said first cylinder which is obtained from said cylinder internal pressure detector at said suction starting time, P₁ is a pressure within said first cylinder which is obtained from said cylinder internal pressure detector at said compression starting time, P₂ is a pressure within said discharge side flow passage which is obtained from said pressure within the discharge side flow at said compression starting time, Kᵢₙ is a time change rate of said calculated pressure within the first cylinder, and Sₛ is said third elapsed time.

5. A liquid delivery device as claimed in claim 1, wherein said control device measures said first elapsed time and said second elapsed time by counting pulses which are output in correspondence to an amount of rotation of said motor.

6. A liquid delivery device constructed by using two liquid delivery devices as claimed in claim 1, wherein the discharge side flow passages of these two liquid delivery devices are structured such as to be combined with one flow passage.

7. A liquid delivery device constructed by using two liquid delivery devices as claimed in claim 2, wherein the discharge side flow passages of these two liquid delivery devices are structured such as to be combined with one flow passage.

8. A liquid chromatography device constructed by including the liquid delivery device as claimed in claim 1.

9. A liquid chromatography device constructed by including the liquid delivery device as claimed in claim 2.
